(19) United States
(12) Patent Application Publication
(10) Pub. No.: US 2012/0001739 A1
(43) Pub. Date: Jan. 5, 2012

(54) Custom code setting system of a remote control chip

(75) Inventor: Horng-Bin Wang, Hsinchu City (TW)

(73) Assignee: Generalplus Technology Inc., Hsinchu City (TW)

(21) Appl. No.: 13/067,713

(22) Filed: Jun. 22, 2011

(30) Foreign Application Priority Data
Jul. 2, 2010 (TW) 099121880

(51) Int. Cl. G08C 19/16

(52) U.S. Cl. 340/12.28

(57) ABSTRACT

In a custom code setting system of a remote control chip, M keyboard input/output pins are connected to an external keyboard to receive the input of the external keyboard. A first pin is connected to one terminal of an external resistor, while the other terminal of the external resistor is connected to ground, wherein there are N resistance values selectable for the external resistor. A resistance detecting unit is connected to the first resistor to detect the resistance of the first resistor. A second pin is connected to one of the M keyboard input/output pins for setting a custom code. When power on reset occurs, a control logic receives the resistance from the resistance detecting unit, and one of the N×M custom codes is determined according to connection between the second pin and one of the M keyboard input/output pins.

### BACKGROUND OF THE INVENTION

1. Field of the Invention

The invention relates generally to the technical field of remote controls and, more particularly, to a custom code setting system of a remote control chip.

2. Description of Related Art

Infrared communication is one kind of wireless communication technologies, which doesn't require any physical connection, and is easy to operate. Its cost is pretty low, so it can be applied in many fields, such as computer, PDA, data transmission between mobile phones or remote control devices of TV sets, air conditioners and other home appliances. But infrared transmission is not suitable for use in places with too many barriers. In these places, its transmission distance is limited, and its transmission rate is low. Therefore, there are many restrictions in practical applications.

In order to integrate the transmission between multiple devices, the Infrared Data Association was established in 1993 in order to build up a unified infrared communication standard. In 1994 IrDA1.0 specification was published. In addition to IrDA1.0 specification, current products may use different specification in the market. Some manufacturers even design their own infrared specifications, such as PD6122 provided by NEC and RC-5 and RC-6 provided by Philips, wherein NEC PD6122 is popular among manufacturers, so NEC develops many integrated circuits with similar infrared transmission standard.

The infrared encoding of NEC uses carrier wave's status and length to show the positive and negative logic states. Logic 0 is encoded by a length of carrier wave and a short idle time, and logic 1 is encoded by a length of carrier wave and a long idle time. The length of time has strict requirements, and the carrier wave is composed of fixed-frequency pulses.

A complete remote control code of NEC PD6122 includes a leader code, a custom code, an inverse custom code (custom code'), a data code, an inverse data code (data code') and a stop code.

FIG. 1 shows the diagram of NEC PD6122 remote control code in the prior art. As shown in FIG. 1, the leader code and stop code are fixed formats, the data code is a serial number, and the custom code is set up via external circuit of integrated circuit.

FIG. 2 shows the diagram of NEC PD6122 integrated circuit for setting remote control code in the prior art. As shown in FIG. 2, the general purpose I/O (GPIO) pins KI/O0-KI/O7 of the NEC PD6122 integrated circuit are externally connected to diodes and resistors. When power on reset (POR) occurs, the state of GPIO pins is read to determine the value of custom code. Then, it enters a normal state to transmit data of remote control code.

When a diode is arranged between a CCS pin and a KI/O pin, the higher 8 bits of corresponding custom code are set as “1”. When there is no diode arranged, the corresponding custom code is set as “0”. When a pull-up resistor is arranged on a KI/O pin, the lower 8 bits of corresponding inverse custom code (custom code') are set as “1”. When there is no diode arranged, the corresponding inverse custom code is set as “0”. When one bit of the inverse custom code is set as “1”, the corresponding bit of the custom code is not inverted, which is further written into the bit of the inverse custom code. When one bit of the inverse custom code is set as “0”, the corresponding bit of the custom code is inverted, which is further written the bit of the inverse custom code.

FIG. 3 shows a diagram of one example of NEC PD6122 integrated circuit for setting remote control code in the prior art. Because diodes are arranged on KI/O0, IU/O4 and KI/O6 pins, the higher 8-bits of custom code are set as “10001010” as shown in FIG. 4. Because the pull-up resistors are arranged on KI/O0 and KI/O4 pins, the lower 8-bits of inverse custom code are set as “10001000” as shown in FIG. 5. Due to that the bit 0 and bit 4 of inverse custom code are set as “1”, the bit 0 and bit 4 of custom code are not inverted, and are written into the bit 0 and bit 4 of the inverse custom code. Due to that the bit 1, bit 2, bit 3, bit 5, bit 6 and bit 7 of the inverse custom code are set as “0”, the bit 1, bit 2, bit 3, bit 5, bit 6 and bit 7 of the custom code are inverted, and are written into the bit 1, bit 2, bit 3, bit 5, bit 6 and bit 7 of the custom code. Finally the custom code and the inverse custom code are shown in FIG. 6.

However, as shown in FIG. 2 and FIG. 3, this structure needs 16 pins to be accomplished, and also needs many external pull-up resistors and diodes. Therefore, it increases much cost. Accordingly, there is still a need for the remote control chip custom code system to be improved.

### SUMMARY OF THE INVENTION

The object of the present invention is to provide a custom code setting system of a remote control chip, so as to reduce the number of the integrated circuit packaging pin and the number of external diodes and external resistors, and save production cost.

According to one aspect of the present invention, there is provided a custom code setting system of a remote control chip, which comprises: M keyboard input/output pins connected to external keys for receiving input of the external keys, where M is a positive integer; a first pin connected to one terminal of an external resistor, the other terminal of the external resistor being connected to a low voltage level, wherein the external resistor has a resistance capable of being selected from N values, where N is a positive integer; a resistance detecting unit connected to the first resistor for detecting the resistance of the external resistor; a second pin connected to one of the M keyboard input/output pins for setting a custom code; and a control logic connected to the resistance detecting unit, the M keyboard input/output pins and the second pin for selecting one of N×M custom codes provided by the M keyboard input/output pin and the first pin; wherein, when the remote control chip performs power on reset, the control logic receives the resistance of the external resistor from the resistance detecting unit, and one of the N×M custom codes is determined according to connection between the second pin and one of the M keyboard input/output pins.

According to another aspect of the present invention, there is provided a custom code setting system of a remote control chip, which comprises: M keyboard input/output pins connected to external keys for receiving input of the external keys, where M is a positive integer; a first pin connected to one terminal of a first external resistor, the other terminal of the first external resistor being selectively connected to one of the M keyboard input/output pins, wherein the first external resistor has resistance capable of being selected from N values, where N is a positive integer; a second pin connected to one terminal of a second external resistor, the other terminal of the second external resistor being selectively connected to one of the M keyboard input/output pins, wherein the second external resistor has a resistance capable of being selected from N values; a resistance detecting unit connected to the first pin and the second pin for detecting the resistance of the first external resistor and the resistance of the second external resistor; and a control logic connected to the resistance detecting unit, the M keyboard input/output pins, the first pin and the second pin for selecting one of 2×N×M custom codes provided by the M keyboard input/output pins, the first pin and the second pin; wherein the first external resistor being connected to one of the M keyboard input/output pins is exclusive to the second external resistor being connected to one of the M keyboard input/output pins, and, when the remote control chip performs power on reset, the control logic receives the resistance of the first external resistor or the second external resistor from the resistance detecting unit, and one of the 2×N×M custom codes is determined according to connection between the first pin or the second pin and one of the M keyboard input/output pins.

### BRIEF DESCRIPTION OF THE DRAWINGS

FIG. 1 shows a diagram of NEC PD6122 remote control code in the prior art;

FIG. 2 shows a diagram of NEC PD6122 integrated circuit for setting remote control code in the prior art;

FIG. 3 shows a diagram of one example of NEC PD6122 integrated circuit for setting remote control code in the prior art;

FIG. 4 shows a diagram of higher 8-bits of custom code of the NEC PD6122 in the prior art;

FIG. 5 shows a diagram of lower 8-bits of inverse custom code of the NEC PD6122 in the prior art;

FIG. 6 shows a diagram of custom code of the NEC PD6122 in the prior art;

FIG. 7 shows a diagram of a custom code setting system of a remote control chip in accordance with a preferred embodiment of the present invention;

FIG. 8 shows a diagram of a custom code setting system of a remote control chip in accordance with another preferred embodiment of the present invention; and

FIG. 9 shows a diagram of a custom code setting system of a remote control chip in accordance with a further preferred embodiment of the present invention.

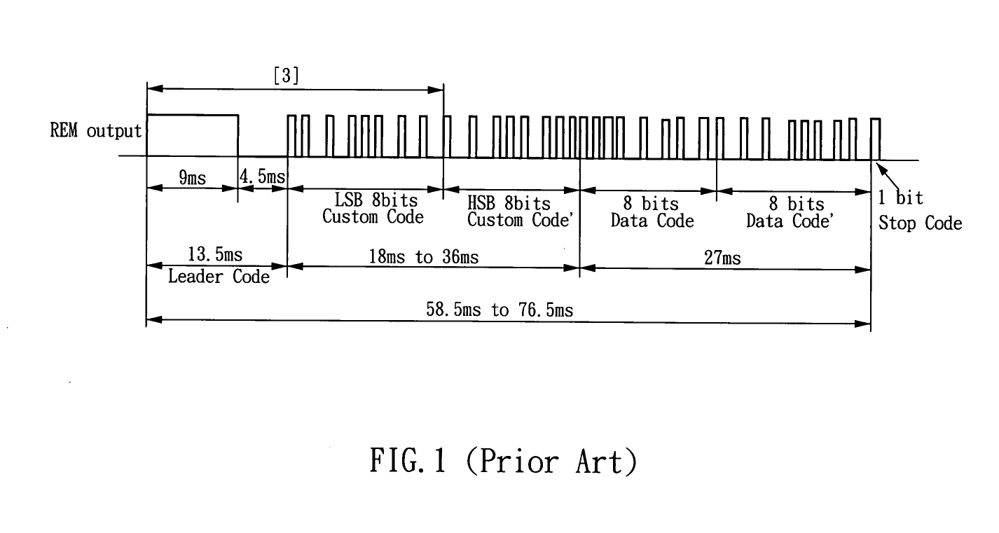

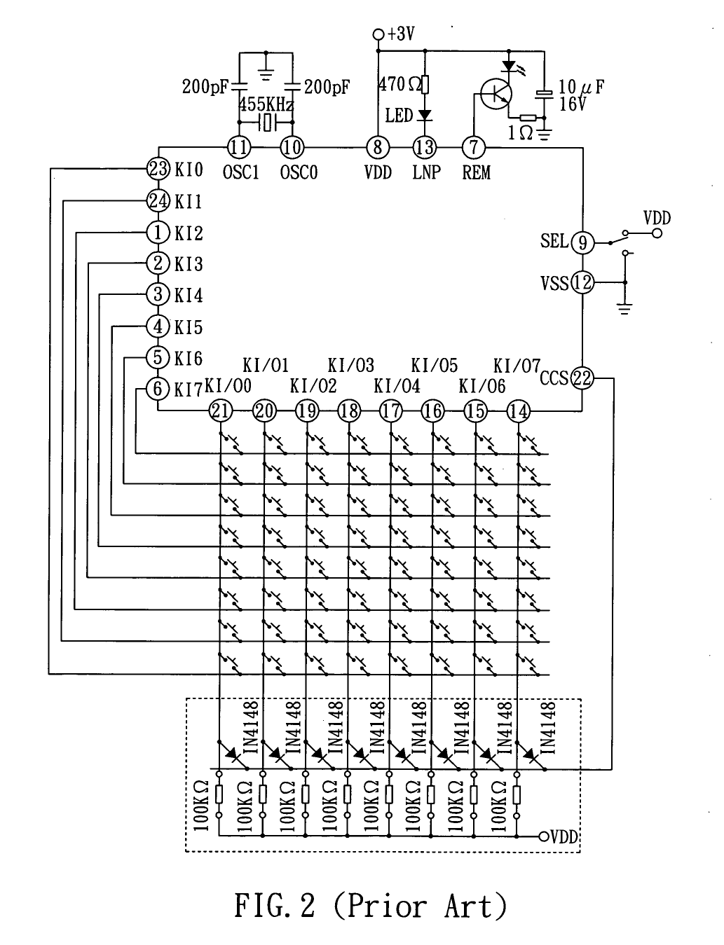

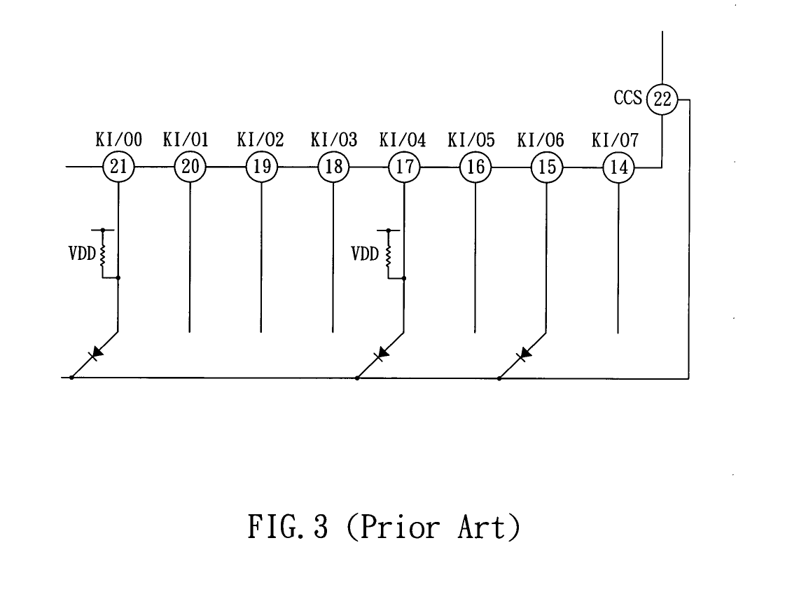

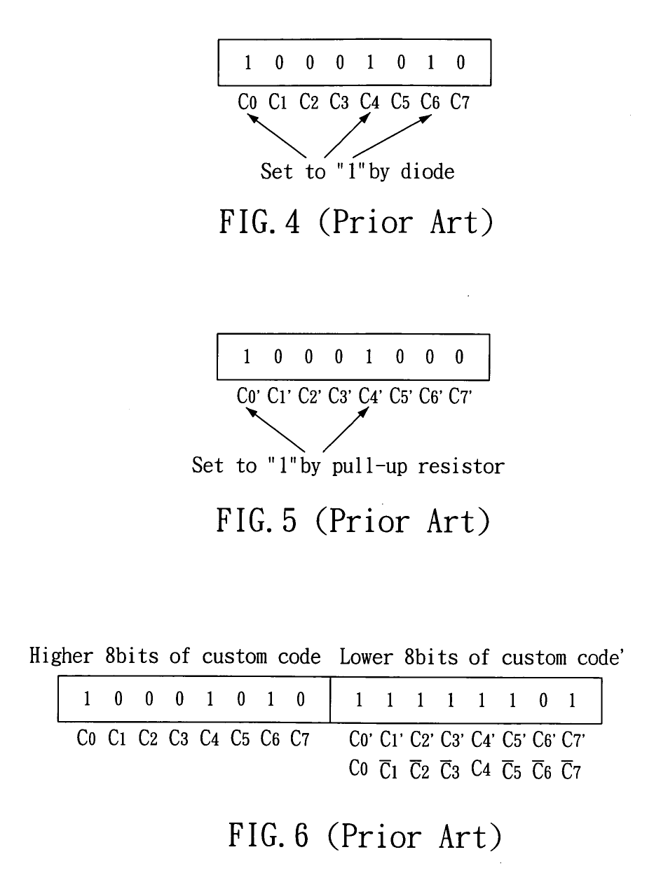

### DETAILED DESCRIPTION OF THE PREFERRED EMBODIMENT

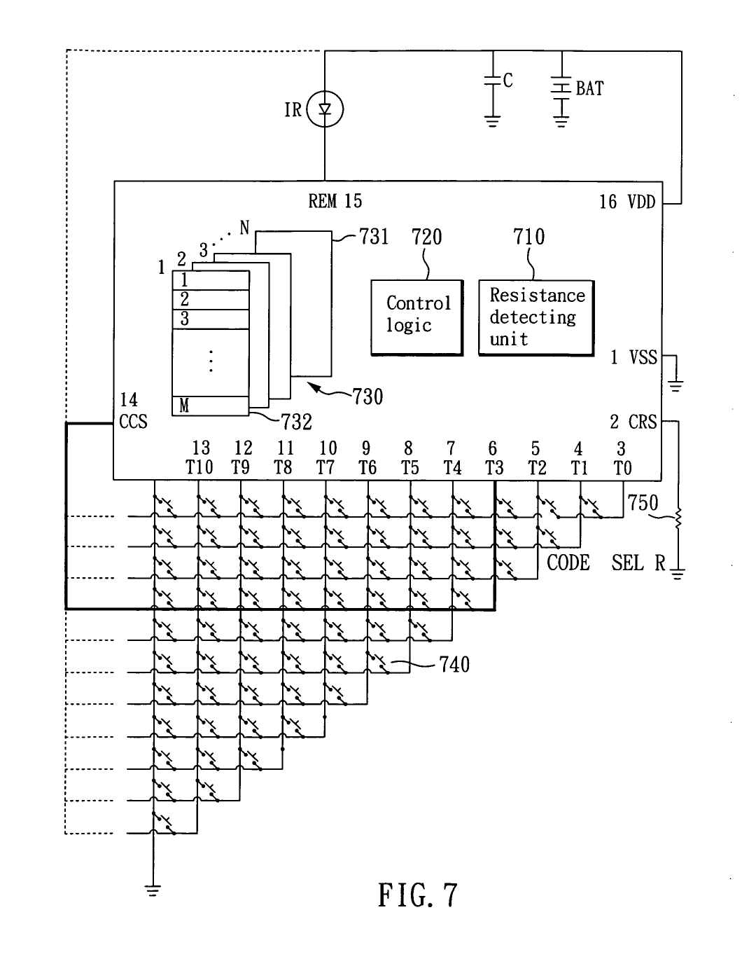

With reference to FIG. 7, there is shown a custom code setting system of a remote control chip in accordance with one preferred embodiment of the invention. As shown, the custom code setting system includes M keyboard input/output pins, a first pin CRS, a resistance detecting unit 710, a second pin CCS, a control logic 720, and a non-volatile memory device 730, where M is a positive integer.

The M keyboard input/output pins are connected to the external key 740 for receiving the input of the external key 740. In this embodiment, M is 11 and the M keyboard input/output pins are labeled as T0-T10.

The first pin CRS is connected to one terminal of an external resistor 750, and the other terminal of the external resistor 750 is connected to a low voltage level, wherein the external resistor 750 has a resistance capable of being selected from N values, where N is a positive integer. In this embodiment, N is 5, which means that the external resistor 750 has five selectable resistances, which can be 0 ohm, 10k ohm, 100k ohm, 1M ohm, and infinite, wherein 0 ohm means that the first pin CRS and the low voltage level are in short circuit, and infinite means that the first pin CRS and the low voltage level are in open circuit.

The resistance detecting unit 710 is connected to the first pin CRS for detecting the resistance of the external resistor 750.

The second pin CCS is connected to one of the M keyboard input/output pins for setting a custom code.

The control logic 720 is connected to the resistance detecting unit 710, the M keyboard input/output pins T0-T10 and the second pin CCS for selecting one of N×M custom codes provided by the M keyboard input/output pin and the first pin CRS.

The non-volatile memory device 730 is connected to the control logic 720. The non-volatile memory device 730 has N tables 731. Each table has M entries 732, and each entry 732 records a custom code. The non-volatile memory device 730 is a read-only memory or flash memory.

When the remote control chip performs power on reset (POR), the control logic 720 receives the resistance of the external resistor 750 from the resistance detecting unit 710, and one of the N×M custom codes is determined according to connection relationship between the second pin CCS and one of the M keyboard input/output pins T0-T10.

The control logic 720 selects one of the N tables 731 according to the resistance of the external resistor 750, and then selects one of the M entries 732 of the table according to the connection relationship between the second pin CCS and one of the M keyboard input/output pins T0-T10.

When the remote control chip finishes power on reset, the second pin CCS is floating.

As shown in FIG. 7, the second pin CCS and the M keyboard input/output pin T3 are connected with each other, so the control logic 720 selects the fourth entry 732 of table 731 as the custom code.

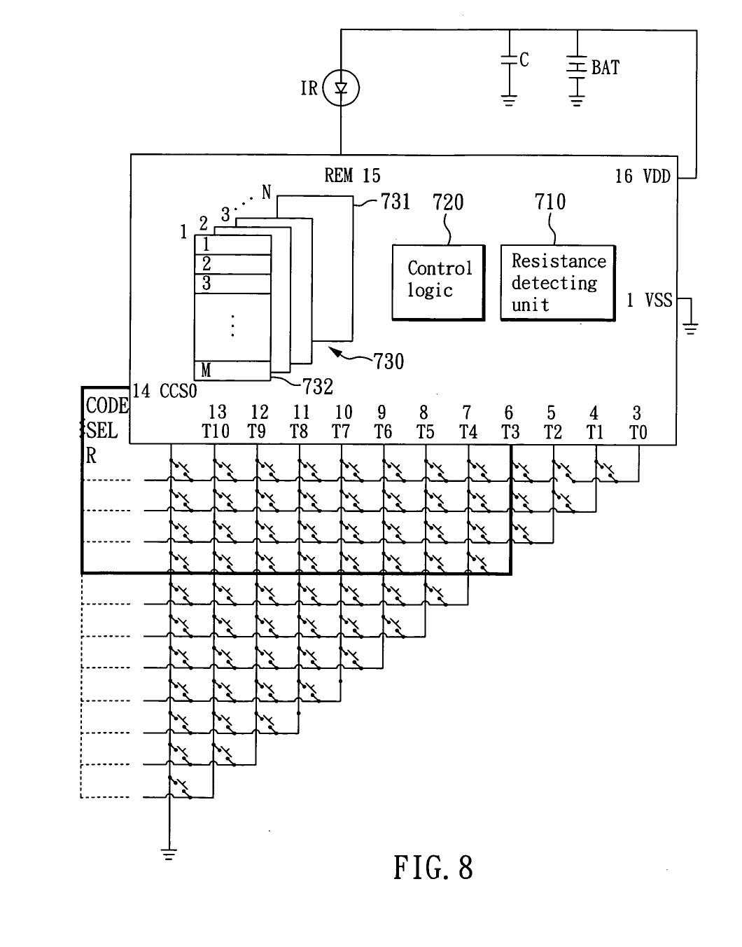

FIG. 8 shows a diagram of a custom code setting system of a remote control chip in accordance with another preferred embodiment of the present invention. This embodiment is different from the previous embodiment, shown by FIG. 7, in that the first pin CRS is not used and the external resistor 750 is arranged directly between a second pin CCS0 and the M keyboard input/output pins T0-T10. When the remote control chip performs power on reset, the control logic 720 receives the resistance of the external resistor 750 from the resistance detecting unit 710, and one of the N×M custom codes is determined according to connection relationship between the second pin CCS0 and one of the M keyboard input/output pins T0-T10.

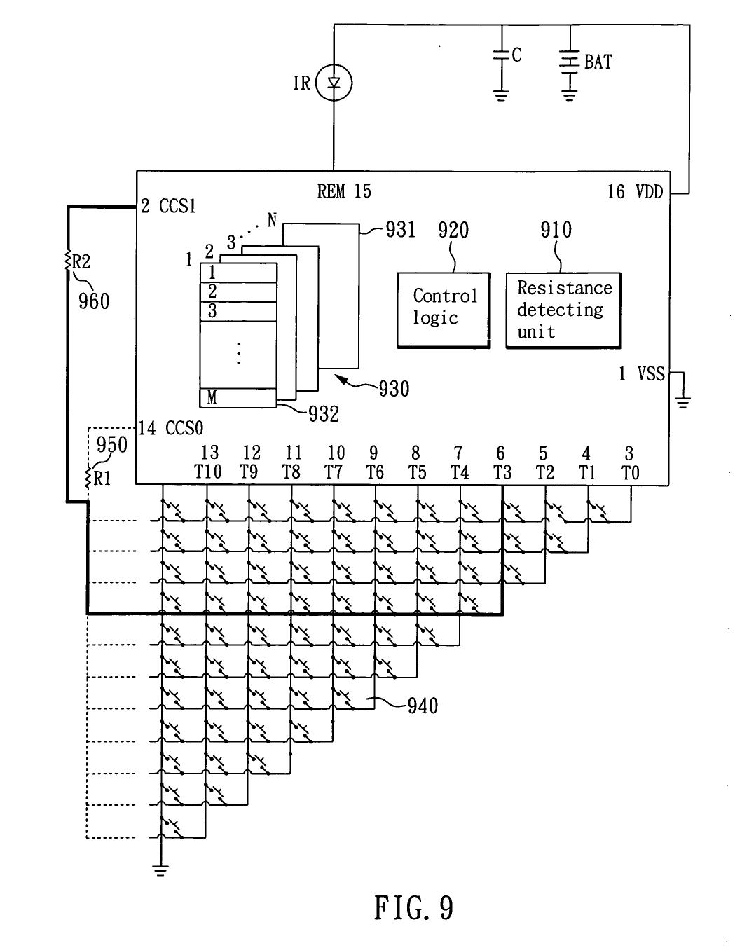

FIG. 9 shows a diagram of a custom code setting system of a remote control chip in accordance with a further preferred embodiment of the present invention. The system includes M keyboard input/output pins, a first pin CCS0, a second pin CCS1, a resistance detecting unit 910, a control logic 920, and a non-volatile memory device 930.

The M keyboard input/output pins are connected to an external key 940 for receiving the input of the external key 940, where M is a positive integer. In this embodiment, M is 11 and the M keyboard input/output pins are labeled as T0-T10.

The first pin CCS0 is connected to one terminal of an first external resistor 950, and the other terminal of the first external resistor 950 is connected to one of the M keyboard input/output pins T0-T10, wherein the external first resistor 950 has a resistance capable of being selected from N values, where N is a positive integer. In this embodiment, N is 5, which means that the external first resistor 950 has five selectable resistances, which can be 0 ohm, 10k ohm, 100k ohm, 1M ohm, and infinite, wherein 0 ohm means that the first pin CCS0 and one of the M keyboard input/output pins T0-T10 are in short circuit, and infinite means that the first pin CCS0 and one of the M keyboard input/output pins T0-T10 are in open circuit.

The second pin CCS1 is connected to one terminal of an second external resistor 960, and the other terminal of the second external resistor 960 is connected to one of the M keyboard input/output pins T0-T10, wherein the external second resistor 960 has a resistance capable of being selected from N values, where N is a positive integer. In this embodiment, N is 5, which means that the external second resistor 960 has five selectable resistances, which can be 0 ohm, 10k ohm, 100k ohm, 1M ohm, and infinite, wherein 0 ohm means that the second pin CCS1 and one of the M keyboard input/output pins T0-T10 are in short circuit, and infinite means that the second pin CCS1 and one of the M keyboard input/output pins T0-T10 are in open circuit.

The resistance detecting unit 910 is connected to the first pin CCS0 and the second pin CCS1 for detecting the resistances of the first external resistor 950 and the second external resistor 960.

The control logic 920 is connected to the resistance detecting unit 910, the M keyboard input/output pins T0-T10, the first pin CCS0 and the second pin CCS1.

The non-volatile memory device 930 is connected to the control logic 920. The non-volatile memory device 930 has 2N tables 931. Each table has M entries 932, and each entry 932 records a custom code. The non-volatile memory device 930 is a read-only memory or flash memory. The 2N tables 931 can be divided into front N tables 931 and rear N tables 931, which are corresponding to the first pin CCS0 and the second pin CCS1, respectively.

The first external resistor 950 being connected to one of the M keyboard input/output pins T0-T10 is exclusive to the second external resistor 960 being connected to one of the M keyboard input/output pins T0-T10. That is, when the first external resistor 950 is connected to one of the M keyboard input/output pins T0-T10, the second external resistor 960 is not arranged and, at this moment, the second external resistor 960 is not connected to one of the M keyboard input/output pins T0-T10. When the second pin CCS1 is connected to one of the M keyboard input/output pins T0-T10 via the second external resistor 960, the first external resistor 950 is not arranged and, at this moment, the first external resistor 950 is not connected to one of the M keyboard input/output pins T0-T10.

When the remote control chip performs power on reset, the control logic 920 receives the resistance of the first external resistor 950 or the second external resistor 960 from the resistance detecting unit 910, and one of the 2×N×M custom codes is determined according to the connection relationship between the first pin CCS0 or the second pin CCS1 and one of the M keyboard input/output pins T0-T10.

The control logic 920 selects one of the 2N tables 931 according to the resistance of the first external resistor 950 or the second external resistor 960, and then selects one of the M entries 932 of the table according to the connection relationship between the first pin CCS0 or the second pin CCS1 and one of the M keyboard input/output pins T0-T10.

When the remote control chip finishes power on reset, the first pin CCS0 and the second pin CCS1 are floating.

As shown in FIG. 9, the second pin CCS1 is connected to the keyboard input/output pin T3 via the second external resistor 960. At this moment, the first external resistor 950 is not arranged, and thus the control logic 920 detects that only the second pin CCS1 is connected to one of the M keyboard input/output pins T0-T10, and the first pin CCS0 is not connected to one of the M keyboard input/output pins T0-T10. The control logic 920 can select one of the rear N tables 931 according to the resistance of the second external resistor 960. Due to that the second pin CCS1 is connected to the keyboard input/output pin T3, the control logic 920 selects the fourth entry 932 of table 931 as the custom code.

When the remote control chip finishes power on reset, the control logic 920 receives a custom code, and the first pin CCS0 and the second pin CCS1 are floating so as to avoid influencing the function of the M keyboard input/output pins T0-T10.

The increment of non-volatile memory device and resistance detecting unit in an integrated circuit only increases little cost, while the cost of integrated circuit packaging pin, the external diode and the external resistor is much higher than that of non-volatile memory device and resistance detecting unit. With the rapid development of semiconductor manufacturing, the increment of non-volatile memory device and resistance detecting unit in an integrated circuit increases very little cost, while the costs of integrated circuit packaging, external diode and external resistors will not decrease with the rapid development of semiconductor manufacturing. Therefore, the present invention can save more cost than that of prior art.

In summary, the present invention can reduce the number of the integrated circuit packaging pin, the external diode and external resistors so as to save the production cost.

Although the present invention has been explained in relation to its preferred embodiment, it is to be understood that many other possible modifications and variations can be made without departing from the scope of the invention as hereinafter claimed.

What is claimed is:

1. A custom code setting system of a remote control chip, comprising:
M keyboard input/output pins connected to external keys for receiving input of the external keys, where M is a positive integer;
a first pin connected to one terminal of an external resistor, the other terminal of the external resistor being connected to a low voltage level, wherein the external resistor has a resistance capable of being selected from N values, where N is a positive integer;
a resistance detecting unit connected to the first resistor for detecting the resistance of the external resistor;
a second pin connected to one of the M keyboard input/output pins for setting a custom code; and
a control logic connected to the resistance detecting unit, the M keyboard input/output pins and the second pin for selecting one of N×M custom codes provided by the M keyboard input/output pin and the first pin;
wherein, when the remote control chip performs power on reset, the control logic receives the resistance of the external resistor from the resistance detecting unit, and one of the N×M custom codes is determined according to connection between the second pin and one of the M keyboard input/output pins.

2. The custom code setting system of a remote control chip as claimed in claim 1, further comprising:
a non-volatile memory device connected to the control logic, the non-volatile memory device having N tables, each table having M entries, each entry recording a custom code.

3. The custom code setting system of a remote control chip as claimed in claim 2, wherein the control logic selects one of the N tables according to the resistance of the external resistor, and then selects one of the M entries of the table according to the connection between the second pin and one of the M keyboard input/output pins.

4. The custom code setting system of a remote control chip as claimed in claim 3, wherein the non-volatile memory device is a read-only memory or flash memory.

5. The custom code setting system of a remote control chip as claimed in claim 4, wherein the second pin is floating after power on reset is finished.

6. A custom code setting system of a remote control chip, comprising:
M keyboard input/output pins connected to external keys for receiving input of the external keys, where M is a positive integer;
a first pin connected to one terminal of a first external resistor, the other terminal of the first external resistor being selectively connected to one of the M keyboard input/output pins, wherein the first external resistor has resistance capable of being selected from N values, where N is a positive integer;
a second pin connected to one terminal of a second external resistor, the other terminal of the second external resistor being selectively connected to one of the M keyboard input/output pins, wherein the second external resistor has a resistance capable of being selected from N values;
a resistance detecting unit connected to the first pin and the second pin for detecting the resistance of the first external resistor and the resistance of the second external resistor; and
a control logic connected to the resistance detecting unit, the M keyboard input/output pins, the first pin and the second pin for selecting one of 2×N×M custom codes provided by the M keyboard input/output pins, the first pin and the second pin;
wherein the first external resistor being connected to one of the M keyboard input/output pins is exclusive to the second external resistor being connected to one of the M keyboard input/output pins, and, when the remote control chip performs power on reset, the control logic receives the resistance of the first external resistor or the second external resistor from the resistance detecting unit, and one of the 2×N×M custom codes is determined according to connection between the first pin or the second pin and one of the M keyboard input/output pins.

7. The custom code setting system of a remote control chip as claimed in claim 6, further comprising:
a non-volatile memory device connected to the control logic, the non-volatile memory device having 2N tables, each table having M entries, each entry recording a custom code.

8. The custom code setting system of a remote control chip as claimed in claim 7, wherein the control logic selects one of the 2N tables according to the resistance of the first external resistor or the second external resistor, and then selects one of the M entries of the table according to connection between the first pin or the second pin and one of the M keyboard input/output pins.

9. The custom code setting system of a remote control chip as claimed in claim 8, wherein the non-volatile memory device is a read-only memory or flash memory.

10. The custom code setting system of a remote control chip as claimed in claim 9, wherein the first pin and the second pin are floating after power on reset is finished.
